(19) United States
(12) Patent Application Publication
(10) Pub. No.: US 2006/0240286 A1
(43) Pub. Date: Oct. 26, 2006

(54) Display device

(75) Inventors: Hae-Il Park, Seoul (KR); In-Sun Hwang, Suwon-si (KR); Sang-Yu Lee, Yongin-si (KR); Jin-Seob Byun, Seoul (KR); Hyoung-Joo Kim, Uiwang-si (KR); Jae-Young Choi, Suwon-si (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd.

(21) Appl. No.: 11/411,292

(22) Filed: Apr. 25, 2006

(30) Foreign Application Priority Data
Apr. 26, 2005 (KR) 2005-34607

(51) Int. Cl. B32B 19/00

(52) U.S. Cl. 428/690

(57) ABSTRACT

A display device includes a light source member, a diffusion member and a display panel. The light source member generates a bluish light. The diffusion member diffuses the bluish light to increase luminance uniformity. The display panel includes a liquid crystal layer, a fluorescent layer and a reflective-polarizing member (a reflective polarizer). The fluorescent layer generates visible light based on the bluish light received from the liquid crystal layer. The reflective-polarizing member partially reflects the visible light generated from the fluorescent layer toward the fluorescent layer. Therefore, luminance and viewing angle are increased.

### CROSS-REFERENCE TO RELATED APPLICATION

The present application claims priority from Korean Patent Application No. 2005-34607, filed on Apr. 26, 2005, the disclosure of which is hereby incorporated herein by reference in its entirety.

### BACKGROUND OF THE INVENTION

1. Field of the Invention

The present invention relates to a display device. More particularly, the present invention relates to a display device capable of improving luminance and viewing angle.

2. Description of the Related Art

A photo-luminescent liquid crystal display (PL-LCD) device, in general, includes a fluorescent pattern and an ultraviolet lamp.

The ultraviolet lamp of the PL-LCD device generates light having various wavelengths, which degrades the color reproducibility of the PL-LCD device.

In addition, when a portion of the light having a wavelength of about 313 nm or about 365 nm is irradiated onto a liquid crystal layer of the PL-LCD device, liquid crystal molecules of the liquid crystal layer are deteriorated.

Furthermore, when the PL-LCD device includes the ultraviolet lamp, the ultraviolet light causes various problems.

Therefore, an adequate light source needs to be adapted to use with PL-LCD devices.

### SUMMARY OF THE INVENTION

The present invention provides a display device capable of improving luminance and viewing angle characteristics of the display device.

A display device in accordance with one aspect of the present invention includes a light source member, a diffusion member and a display panel. The light source member generates a bluish light. The diffusion member diffuses the bluish light to increase luminance uniformity. The display panel includes a liquid crystal layer, a fluorescent layer and a reflective-polarizing member (a reflective polarizer). The fluorescent layer generates visible light based on received bluish light. The reflective-polarizing member partially reflects the visible light generated from the fluorescent layer toward the fluorescent layer.

A wavelength of the bluish light may be about 400 nm to about 500 nm.

The light source member may include at least one of a bluish light emitting diode, a bluish organic light emitting diode, a cold cathode fluorescent lamp and a bluish fluorescent material, an external electrode fluorescent lamp and a bluish fluorescent material, a flat-typed fluorescent lamp and a bluish fluorescent material, etc.

The fluorescent layer may include at least one of a fluorescent material, a color changing material and a photo luminescent material that includes a mixture of the fluorescent material and the color changing material.

The reflective-polarizing member may be on the light source member, and the fluorescent layer may be on the reflective-polarizing member.

The reflective-polarizing member may include a first liquid crystal layer including liquid crystals aligned in a first direction to reflect a light polarized in the first direction, and a second liquid crystal layer on the first liquid crystal layer. The second liquid crystal layer may include liquid crystals aligned in a second direction that is substantially opposite to the first direction to reflect a light polarized in the second direction.

The first liquid crystal layer may include a first liquid crystal film to generate circularly polarized red light of a first wavelength, and a second liquid crystal film to generate circularly polarized green light of a second wavelength.

The second liquid crystal layer may include a third liquid crystal film to generate circularly polarized red light of a first wavelength, and a fourth liquid crystal film to generate circularly polarized green light of a second wavelength.

Each of the first and second liquid crystal layers may include cholesteric liquid crystals.

The reflective-polarizing member may include a plurality of layers, at least some of which have different refractive indexes.

The display panel may include a first substrate including a first base substrate and a pixel electrode on the first base substrate, and a second substrate attached to the first substrate to receive the liquid crystal layer. The second substrate may include a second base substrate, the fluorescent layer, the reflective-polarizing member and a common electrode.

The second substrate may further include a black matrix to define a plurality of pixel regions (which may be referred to generally as “pixels” herein) positioned corresponding to associated fluorescent portions of the fluorescent layer. A wavelength of the bluish light may be about 400 nm, and the fluorescent layer may include a red fluorescent layer and a green fluorescent layer.

The display panel may include a first substrate including a first base substrate and a pixel electrode on the first base substrate, and a second substrate attached to the first substrate to receive the liquid crystal layer. The second substrate may include a second base substrate, a color filter layer, the fluorescent layer, the reflective-polarizing member and the common electrode. The second substrate may further include a second black matrix to define a plurality of pixels corresponding to associated fluorescent portions of the fluorescent layer.

A wavelength of the bluish light may be about 400 nm, and the fluorescent layer may include a red fluorescent layer and a green fluorescent layer.

The display panel may include a first substrate including a first base substrate and a pixel electrode on the first base substrate, and a second substrate attached to the first substrate to receive the liquid crystal layer. The second substrate may include a second base substrate, the fluorescent layer on a first surface of the second base substrate, the reflective-polarizing member on the first surface of the second base substrate and a color filter layer on a second surface of the second base substrate.

The display panel may include a first substrate, a second substrate and a third substrate. The first substrate may include a first base substrate and a pixel electrode on the first base substrate. The second substrate may be attached to the first substrate to receive the liquid crystal layer, and may include a second base substrate, the fluorescent layer on a first surface of the second base substrate, the reflective-polarizing member on the first surface of the second base substrate and a common electrode on the first surface of the second base substrate. The third substrate may be on a second surface of the second base substrate, and may include a third base substrate and a color filter layer on the third base substrate.

A display device in accordance with another aspect of the present invention includes a light source member, a diffusion member and a display panel. The light source member generates a bluish light having a wavelength of about 400 nm to about 500 nm. The diffusion member diffuses the bluish light to increase luminance uniformity. The display panel includes a liquid crystal layer, a fluorescent layer and a reflective-polarizing member. The fluorescent layer generates a first visible light based on the bluish light received from the liquid crystal layer. The reflective-polarizing member partially reflects the first visible light generated by the fluorescent layer toward the fluorescent layer.

A display device in accordance with still another aspect of the present invention includes a light source member, a diffusion member and a display panel. The light source member generates a bluish light having a wavelength of about 400 nm to about 500 nm. The diffusion member diffuses the bluish light to increase a luminance uniformity. The display panel includes a liquid crystal layer, a fluorescent layer, a reflective-polarizing member and a color filter layer. The fluorescent layer generates a first visible light based on the bluish light received from the liquid crystal layer. The reflective-polarizing member partially reflects the first visible light generated from the fluorescent layer toward the fluorescent layer. The color filter layer converts the first visible light into a second visible light.

A wavelength of the bluish light may correspond to a wavelength of a maximum intensity. Red, green and blue color filter layers may include red, green and blue color filter portions, respectively. Red, green and blue fluorescent layers may be red, green and blue fluorescent portions, respectively.

In general, in another aspect, a display apparatus includes a light source configured to generate light having an intensity maximum at a wavelength included in the range from about 400 nm to about 500 nm. The display apparatus further includes a fluorescent layer configured to received light from the light source and further configured to generate first light having an intensity maximum corresponding to a first color and to generate second light having an intensity maximum corresponding to a second color, the fluorescent layer generating the first light and the second light in response to receiving the light from the light source. The display apparatus may be included in a display device (e.g., and LCD display, an OLED, and/or other display device type).

According to embodiments of the present invention, the PL-LCD device displays the image using the bluish light to increase the luminance of the display device. In addition, the light source includes the fluorescent layer that generates the light of a Lambertian distribution, thereby increasing the viewing angle.

### BRIEF DESCRIPTION OF THE DRAWINGS

The above and other advantages of the present invention will become more apparent by describing in detail exemplary embodiments thereof with reference to the accompanying drawings, in which:

FIG. 1 is a perspective view showing a display device in accordance with one embodiment of the present invention;

FIG. 2 is a perspective view showing a backlight assembly in accordance with another embodiment of the present invention;

FIG. 3 is a cross-sectional view showing a display panel shown in FIG. 1;

FIG. 4 is a cross-sectional view showing a reflective-polarizing layer shown in FIG. 3;

FIG. 5 is a cross-sectional view showing a first liquid crystal layer shown in FIG. 4;

FIG. 6 is a cross-sectional view showing a second liquid crystal layer shown in FIG. 4;

FIG. 7 is a first liquid crystal film shown in FIG. 5;

FIG. 8 is a flow chart showing a method of manufacturing the reflective-polarizing layer shown in FIG. 4;

FIGS. 9A and 9B are cross-sectional views showing the first liquid crystal film and a second liquid crystal shown in FIG. 5;

FIG. 10 is a cross-sectional view showing the first liquid crystal layer shown in FIG. 4;

FIG. 11 is a cross-sectional view showing a display device in accordance with another embodiment of the present invention;

FIG. 12 is a cross-sectional view showing a display device in accordance with another embodiment of the present invention;

FIG. 13 is a cross-sectional view showing a display device in accordance with another embodiment of the present invention;

FIG. 14 is a perspective view showing a display device in accordance with another embodiment of the present invention;

FIG. 15 is a cross-sectional view showing a display device shown in FIG. 14;

FIG. 16 is a perspective view showing a backlight assembly in accordance with another embodiment of the present invention;

FIG. 17 is a perspective view showing a backlight assembly in accordance with another embodiment of the present invention;

FIG. 18 is a perspective view showing a backlight assembly in accordance with another embodiment of the present invention; and

FIG. 19 is a graph showing a relationship between an intensity and a wavelength of a light generated from a bluish light source.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully describe the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. Reference to an element as “first” does not imply the need for a “second” or other additional element.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

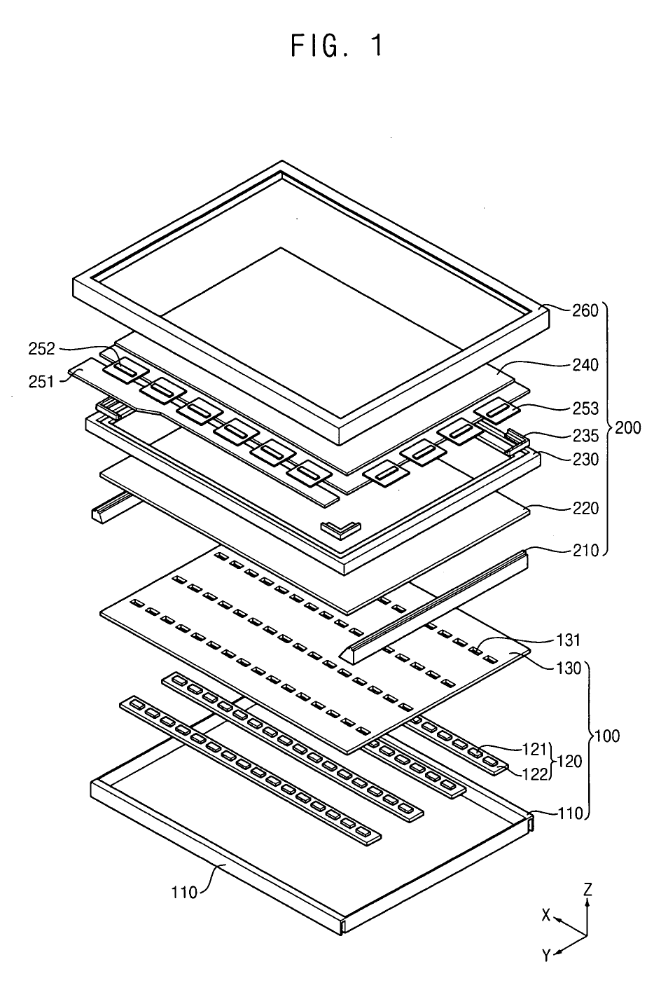

FIG. 1 is a perspective view showing a display device in accordance with one embodiment of the present invention.

Referring to FIG. 1, the display device includes a backlight assembly 100 and a display assembly 200. The backlight assembly 100 generates a bluish light. The backlight assembly 200 displays an image based on the bluish light.

The backlight assembly 100 includes a bottom chassis 110, a light source member 120 and a reflecting plate 130. The bottom chassis 110 has a receiving space to receive the light source member 120 and the reflecting plate 130.

The light source member 120 may be of a direct illumination type. The light source member 120 includes a plurality of light emitting diodes 121 and a printed circuit board 122. Each of the light emitting diodes 121 generates bluish light having a wavelength of about 400 nm to about 500 nm. For example, each of the light emitting diodes 121 may have a chip shape. It is noted that the bluish light includes light of more than one wavelength. The wavelength range herein refers to the wavelength at which the intensity of the bluish light is maximum.

The light emitting diodes 121 are mounted on the printed circuit board 123 along a longitudinal direction of the printed circuit board 122. An inverter (not shown) is electrically connected to the printed circuit board 122 to apply electric power to the light emitting diodes 121.

The reflecting plate 130 is positioned on the printed circuit board 122 having the light emitting diodes 121 so that the bluish light generated by the light emitting diodes 121 is reflected from the reflecting plate 130 toward a front of the backlight assembly 100. In particular, a plurality of holes 131 is formed through the reflecting plate 130 at positions corresponding to the positions of the light emitting diodes 121, so that the light emitting diodes 121 are received in associated holes 131.

The display assembly 200 includes a side mold 210, a diffusion plate 220, an upper mold 230, a display panel 240 and a top chassis 260.

The side mold 210 guides the portion of backlight assembly 100 that is under the side mold 210, and supports the diffusion plate 220 that is on the side mold 210. The diffusion plate 220 diffuses the bluish light generated from the backlight assembly 100 to supply the display panel 240 with the diffused bluish light.

The upper mold 230 may have a frame shape. The display panel 240 that is guided by a panel guide 235 is received in the upper mold 230. The upper mold 230 is combined with the side mold 210 to fix the diffusion plate 220 to the side mold 210.

The display panel 240 is received in the upper mold 230, and includes a first substrate, a second substrate, a liquid crystal layer and color fluorescent layers. The color fluorescent layers include a red fluorescent layer, a green fluorescent layer and a blue fluorescent layer. The liquid crystal layer is interposed between the first and second substrates. The red, green and blue fluorescent layers generate red light, green light and blue light, respectively. Alternatively, the blue fluorescent layer may be omitted. The display panel 240 displays an image using electrical and optical characteristics of the liquid crystals.

Each of the color fluorescent layers may include a fluorescent material, a color changing material, a photo luminescent material, etc. The photo luminescent material may be a mixture of the fluorescent material and the color changing material. The light generated from the color fluorescent layers has a Lambertian distribution to increase a viewing angle of the display device. For example, the viewing angle is an angle with respect to a direction normal to the front surface of the display device having of a contrast ratio of about 10:1.

The fluorescent material may include a red fluorescent material, a green fluorescent material, a blue fluorescent material, and/or other fluorescent material. The red fluorescent material changes the bluish light into red light. The green fluorescent material changes the bluish light into green light. The blue fluorescent material changes the bluish light into blue light. Alternatively, the blue fluorescent material may be omitted.

The color changing material includes a red color changing material, a green color changing material and a blue color changing material. The red color changing material changes the bluish light into red light. The green color changing material changes the bluish light into green light. The blue color changing material changes the bluish light into blue light. Alternatively, the blue color changing material may be omitted.

A driving unit is mounted on a peripheral region of the display panel 250. The driving unit includes a source printed circuit board 251, a data driving part 252 and a gate driving part 253. The source printed circuit board 251 includes a driving circuit configured to generate driving signals.

The top chassis 260 may have a frame shape. The top chassis 260 is combined with the upper mold 230 to fix the display panel 240 to the upper mold 230. In addition, the top chassis 260 is combined with the bottom chassis 110 to fix the backlight assembly 100 and the display assembly 200 to the bottom chassis 110.

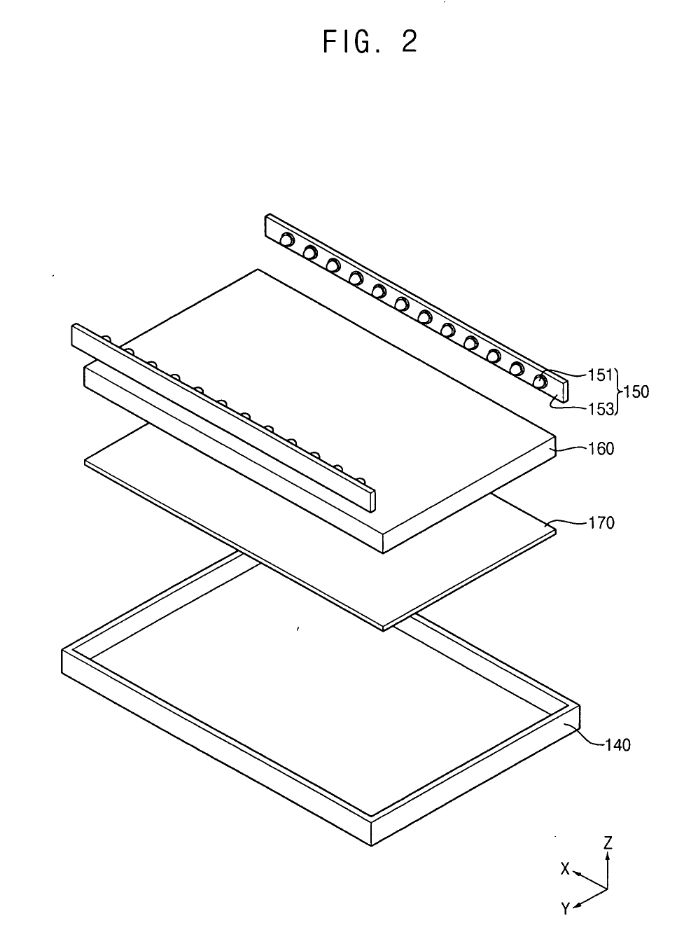

FIG. 2 is a perspective view showing a backlight assembly in accordance with another embodiment of the present invention.

Referring to FIG. 2, the backlight assembly includes a bottom chassis 140, a light source member 150, a light guiding plate 160 and a reflecting plate 170. The bottom chassis 140 has a receiving space to receive the light source member 150, the light guiding plate 160 and the reflecting plate 170.

The light source member 150 may be of an edge illumination type. In the illustrated embodiment, the light source member 150 includes a plurality of light emitting diodes 151 and a printed circuit board 153. Each of the light emitting diodes 151 generates a bluish light having a wavelength of about 400 nm to about 500 nm. For example, each of the light emitting diodes 151 may have a light emitting diode chip and an optical lens covering the light emitting diode chip. The optical lens may have a semi-spherical shape.

The light emitting diodes 151 are mounted on the printed circuit board 153 along a longitudinal direction of the printed circuit board 153. An inverter (not shown) is electrically connected to the printed circuit board 153 to apply electric power to the light emitting diodes 151.

The light guiding plate 160 guides the bluish light generated from the light emitting diodes 151 in a generally point shape or a generally linear shape toward a display panel. The guided bluish light that is guided by the light guiding plate 160 may have a generally planar shape.

The guided bluish light exiting the light guiding plate 160 is reflected from the reflecting plate 170 toward the front of the backlight assembly.

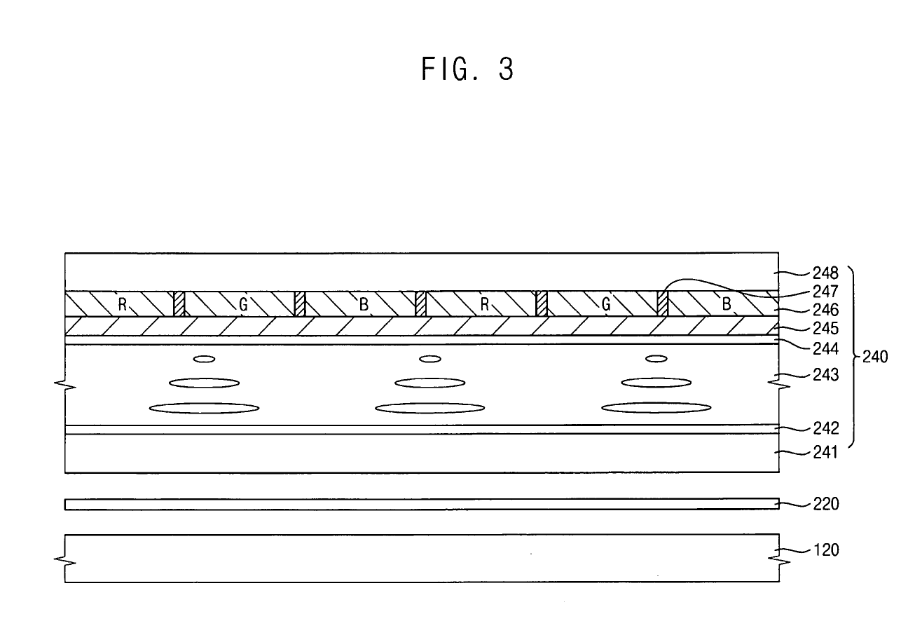

FIG. 3 is a cross-sectional view showing a display panel shown in FIG. 1.

Referring to FIG. 3, the display device includes a light source member 120, a diffusion plate 220 and a display panel 240. 15 The light source member 120 generates bluish light having a wavelength of about 400 nm to about 500 nm.

The diffusion plate 220 diffuses the light generated from the light source member 120 to increase luminance uniformity.

The display panel 240 includes a first substrate 241, a second substrate 248 and a liquid crystal layer 243. The second substrate 248 is positioned corresponding to the first substrate 241. The liquid crystal layer 243 is interposed between the first and second substrates 241 and 248.

The second substrate 248 includes a black matrix 247, color fluorescent layers 246, a reflective-polarizing layer 245 and a common electrode 244. The black matrix 247 defines a plurality of regions for the color fluorescent layers 246, respectively. The color fluorescent layers 246 include a red fluorescent layer R, a green fluorescent layer G and a blue fluorescent layer B. The red fluorescent layer R changes the bluish light into red light. The green fluorescent layer G changes the bluish light into green light. The blue fluorescent layer B changes the bluish light into blue light.

Each of the red, green and blue lights generated from the color fluorescent layers 246 may have a Lambertian distribution. In the Lambertian distribution, the light has a substantially spherical shape having a light source at its center.

Each of the color fluorescent layers may include a fluorescent material, a color changing material, a photo-luminescent material having the fluorescent material and the color changing material, etc.

Fluorescent materials are classified as inorganic fluorescent materials and organic fluorescent materials. Examples of inorganic fluorescent materials that can be used for the color fluorescent layers include Y₂O₂S:Eu for the red fluorescent material, (Sr,Ca,Ba,Eu)₁₀(PO₄)₆.Cl₂ for the green fluorescent material, 3(Ba,Mg,Eu,Mn)O.8Al₂O₃ for the blue fluorescent material, etc. Examples of organic fluorescent materials that can be used for the color fluorescent layers include rhodamine B for the red fluorescent material, brilliantsulfoflavine FF for the green fluorescent material, etc.

In FIG. 3, the red fluorescent layer R includes the red fluorescent material that changes the bluish light into the red light. The green fluorescent layer G includes the green fluorescent material that changes the bluish light into the green light. The blue fluorescent layer B includes the blue fluorescent material that changes the bluish light into the blue light.

Alternatively, the blue fluorescent layer B may include a transparent material. The blue fluorescent layer B may also be omitted. For example, when the wavelength of the bluish light is about 460 nm, an energy level of the bluish light is relatively low. Under these circumstances, it may be beneficial to include a blue fluorescent layer B in the second substrate 248. However, when the wavelength of the bluish light is about 400 nm, the energy level of the bluish light is relatively high, and the blue fluorescent layer B may be omitted in the second substrate 248. Also, the second substrate 248 may include transparent material corresponding to the blue fluorescent layer B.

The reflective-polarizing layer 245 transmits the bluish light and the blue light, while the red and green lights are reflected from the reflective-polarizing layer 245. The reflected red and green lights are incident on the color fluorescent layer 246 to increase the luminance of the display panel.

In FIG. 3, the reflective-polarizing layer 245 may include one or more multi-layered liquid crystal layers including cholesteric liquid crystals. Alternatively, the reflective-polarizing layer 245 may include a plurality of anisotropy layers having different refractive indexes.

The common electrode 244 corresponds to the pixel electrode 242. When a potential difference is applied to the common electrode 244 and the pixel electrode 242, an electric field is formed between the common electrode 244 and the pixel electrode 242. The liquid crystals of the liquid crystal layer 243 vary their arrangement in response to the electric field applied thereto, and thus the local light transmittance of the liquid crystal layer is changed.

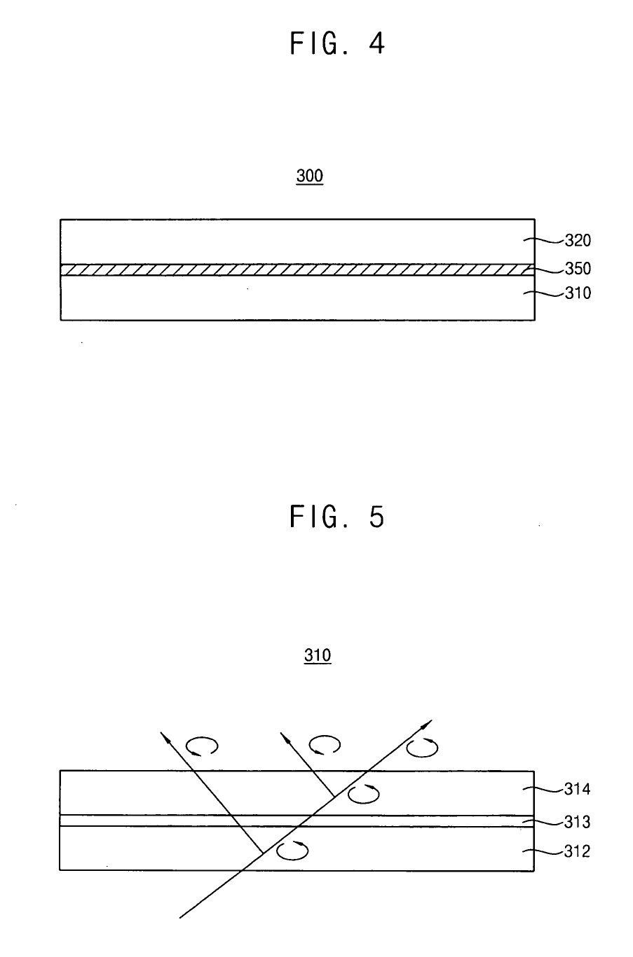

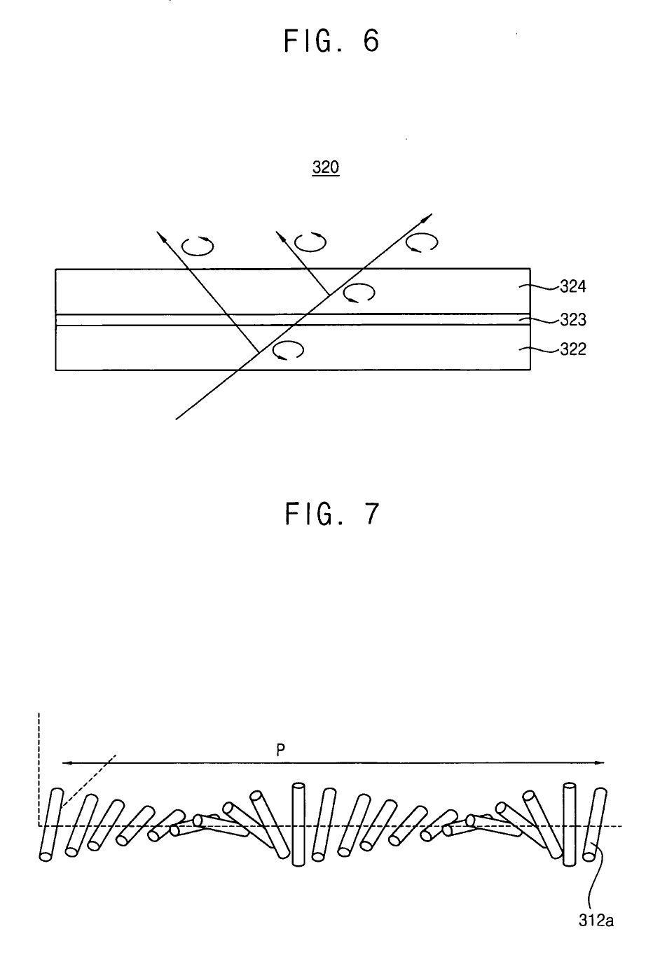

FIG. 4 is a cross-sectional view showing a reflective-polarizing layer shown in FIG. 3. FIG. 5 is a cross-sectional view showing a first liquid crystal layer shown in FIG. 4. FIG. 6 is a cross-sectional view showing a second liquid crystal layer shown in FIG. 4. FIG. 7 is a first liquid crystal film shown in FIG. 5.

Referring to FIGS. 4 to 7, the reflective-polarizing layer 300 includes a first liquid crystal layer 310, a second liquid crystal layer 320 and an adhesive member 350. The first liquid crystal layer 310 is attached to the second liquid crystal layer 320 using the adhesive member 350.

The first liquid crystal layer 310 includes cholesteric liquid crystals arranged with a helical axis in a first direction (toward the top of the page in FIG. 5) so that the light that is polarized in the first direction is reflected from the first liquid crystal layer 310. The cholesteric liquid crystals transmit the light that is polarized in a different direction from the first direction.

The first liquid crystal layer 310 includes a first liquid crystal film 312 and a second liquid crystal film 314. The first liquid crystal film 312 changes linearly polarized red light into circularly polarized red light. The second liquid crystal film 314 changes linearly polarized green light into circularly polarized green light. The second liquid crystal film 314 is positioned proximate to the first liquid crystal film 312. For example, the second liquid crystal film 314 is attached to the first liquid crystal film 312 using a first adhesive layer 313.

In FIG. 7, cholesteric liquid crystals 312a (which are one type of liquid crystal that may be used) are twisted at every pitch P to form a spiral shape.

The second liquid crystal film 314 has a different pitch P than the first liquid crystal film 312. Light having a wavelength that equals the pitch P multiplied by a refractive index of the associated one of the first and second liquid crystal films 312 and 314 is reflected from the associated one of the first and second liquid crystal films 312 and 314. For example, the second liquid crystal film 314 may have a smaller pitch than the first liquid crystal film 312.

Each of the first and second liquid crystal films 312 and 314 includes a mixture of cholesteric liquid crystals and vertically aligned liquid crystals. The ratio of the number of cholesteric liquid crystals to the number of vertically aligned liquid crystals is changed to determine the wavelength of the light that is reflected from each of the first and second liquid crystal films 312 and 314. For example, the ratio of the number of cholesteric liquid crystals to the number of vertically aligned liquid crystals of the first liquid crystal film 312 may be about 8:2, while the ratio of the number of cholesteric liquid crystals to the number of vertically aligned liquid crystals of the second liquid crystal film 314 may be about 7:3.

Light that is polarized in the first direction of the cholesteric liquid crystals of each of the first and second liquid crystal films 312 and 314 is reflected from the first and second liquid crystal films 312 and 314. In addition, each of the first and second liquid crystal films 312 and 314 transmits the light that is polarized in a different direction from the first direction of the cholesteric liquid crystals of each of the first and second liquid crystal films 312 and 314. The reflected light that is reflected from each of the first and second liquid crystal films 312 and 314 may be right circularly polarized light or left circularly polarized light in accordance with the first direction of each of the first and second liquid crystal films 312 and 314. The transmitted light that is transmitted through each of the first and second liquid crystal films 312 and 314 may be left circularly polarized light or right circularly polarized light that has the opposite polarization direction from that of the reflected light.

The second liquid crystal layer 320 includes cholesteric liquid crystals arranged in a second direction that is substantially opposite to the first direction (toward the bottom of the page in FIG. 6) so that the light that is polarized in the second direction is reflected from the second liquid crystal layer 320. The cholesteric liquid crystals transmit the light that is polarized in a different direction from the second direction.

The second liquid crystal layer 320 includes a third liquid crystal film 322 and a fourth liquid crystal film 324. The second liquid crystal film 322 changes linearly polarized green light into circularly polarized green light. The second liquid crystal film 324 changes linearly polarized green light into circularly polarized green light. The fourth liquid crystal film 324 is positioned proximate to the third liquid crystal film 322. For example, the fourth liquid crystal film 324 is attached to the third liquid crystal film 322 using a second adhesive layer 323.

Each of the third and fourth liquid crystal films 322 and 324 includes a mixture of cholesteric liquid crystals and vertically aligned liquid crystals. The ratio of the number of cholesteric liquid crystals to the number of vertically aligned liquid crystals is changed to determine the wavelength of the light that is reflected from each of the third and fourth liquid crystal films 322 and 324.

Light that is polarized in the second direction of the cholesteric liquid crystals of each of the third and fourth liquid crystal films 322 and 324 is reflected from each of the third and fourth liquid crystal films 322 and 324. In addition, each of the third and fourth liquid crystal films 322 and 324 transmits light that is polarized in a different direction from the second direction of the cholesteric liquid crystals of each of the third and fourth liquid crystal films 322 and 324. The reflected light that is reflected from each of the third and fourth liquid crystal films 322 and 324 may be right circularly polarized light or left circularly polarized light in accordance with the second direction of each of the third and fourth liquid crystal films 322 and 324. The transmitted light that is transmitted through each of the third and fourth liquid crystal films 322 and 324 may be left circularly polarized light or right circularly polarized light that has an opposite polarization direction from that of the reflected light.

When the first liquid crystal layer 310 reflects left circularly polarized light and transmits right circularly polarized light, right circularly polarized light having passed through the first liquid crystal layer 310 is reflected from the second liquid crystal layer 320. Therefore, the red light and the green light are reflected by the first and second liquid crystal layers 310 and 320, respectively, so that the reflectivity of each of the first and second liquid crystal layers 310 and 320 is increased.

The adhesive member 350 that attaches the first liquid crystal layer 310 to the second liquid crystal layer 320 may be an adhesive film.

For example, the adhesive film may include an ultraviolet light curable material. When ultraviolet light is irradiated onto an adhesive film including an ultraviolet light curable material, the adhesive film is solidified and the first liquid crystal layer 310 is attached to the second liquid crystal layer 320.

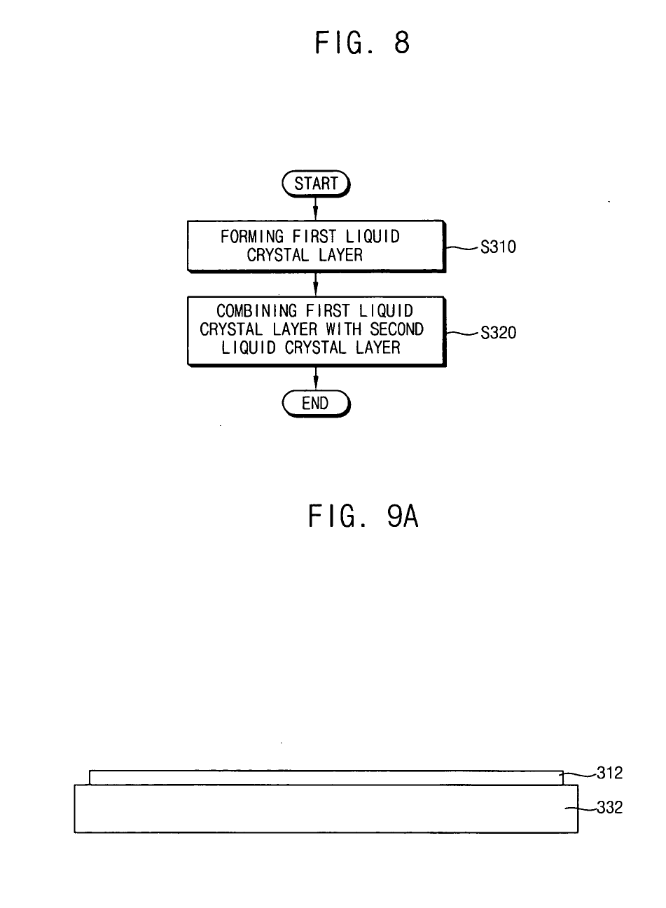

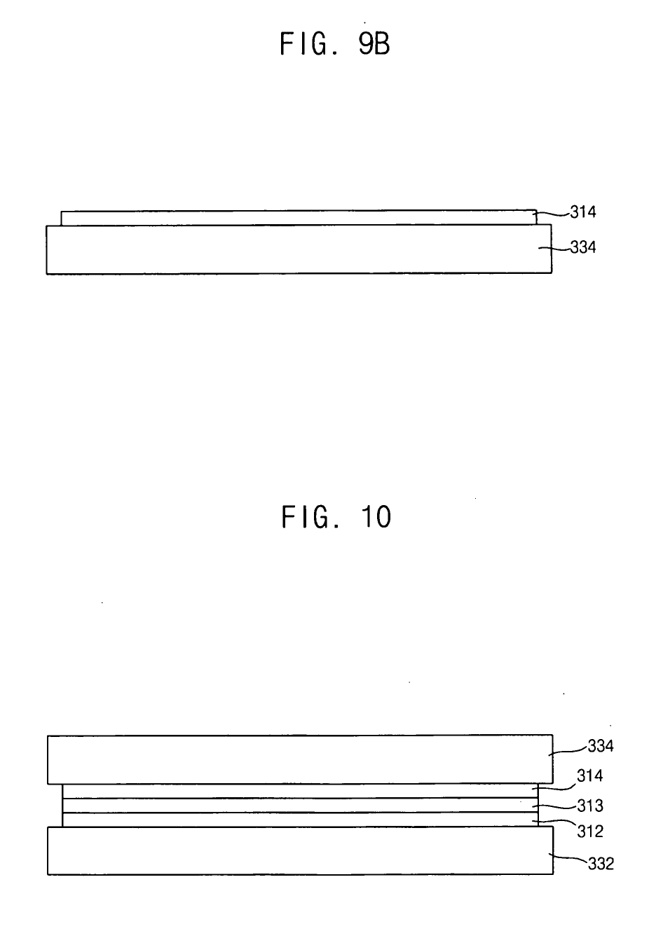

FIG. 8 is a flow chart showing a method of manufacturing the reflective-polarizing layer shown in FIG. 4. FIGS. 9A and 9B are cross-sectional views showing the first liquid crystal film and a second liquid crystal shown in FIG. 5. FIG. 10 is a cross-sectional view showing the first liquid crystal layer shown in FIG. 4.

Referring to FIGS. 8 to 10, the first liquid crystal layer 310 is formed on a substrate 332 (at S310). For example, a first liquid crystal film 312 is formed on the substrate 332, and a second liquid crystal film 314 is formed on an auxiliary substrate 334. Each of the first and second liquid crystal films 312 and 314 may be formed using a coating method.

A first adhesive layer 313 is provided between the first and second liquid crystal films 312 and 314, to attach the first liquid crystal film 312 to the second liquid crystal film 314. The auxiliary substrate 334 is then removed from the second liquid crystal film 314 to form the first liquid crystal layer 310.

A second liquid crystal layer 320 is formed on an opposite substrate (not shown). A method of forming the second liquid crystal layer is substantially same as the method of forming the first liquid crystal layer 310. Thus, further explanation concerning the above elements will be omitted.

An adhesive member 350 is interposed between the first and second liquid crystal layers 310 and 320, to attach the first liquid crystal layer 310 to the second liquid crystal layer 320 (at S320). The opposite substrate (not shown) is then removed from the second liquid crystal layer 320.

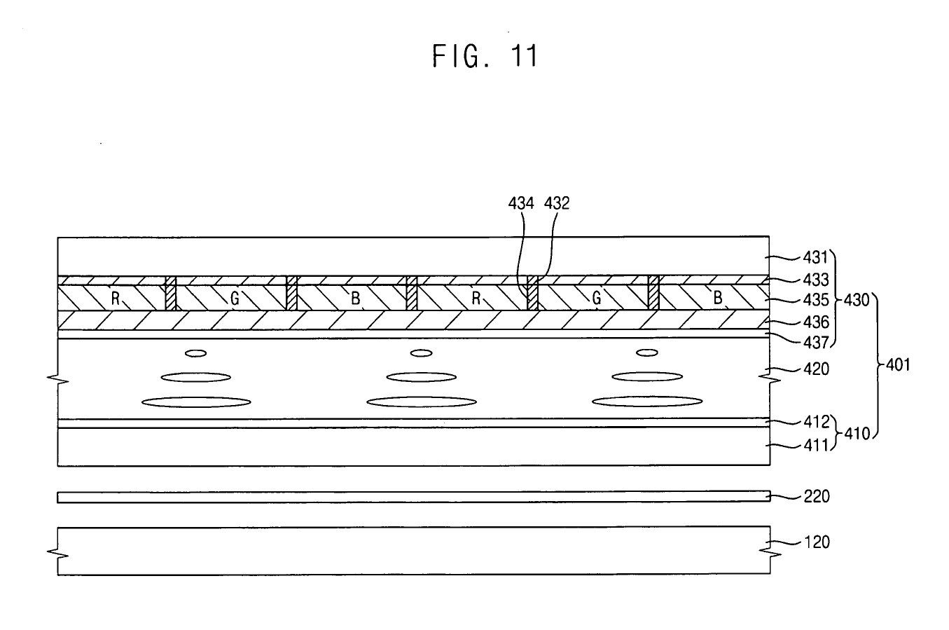

FIG. 11 is a cross-sectional view showing a display device in accordance with another embodiment of the present invention.

Referring to FIG. 11, the display device includes a light source member 120, a diffusion plate 220 and a display panel 401. The light source member 120 and the diffusion plate 220 of FIG. 11 are same as in FIGS. 1 to 7. Thus, the same reference numerals will be used to refer to the same or like parts as those described in FIGS. 1 to 7 and further explanation concerning the above elements may be omitted.

The light source member 120 generates bluish light having a wavelength of about 400 nm to about 500 nm. The diffusion plate 220 diffuses the bluish light generated from the light source member 120 to increase luminance uniformity.

The display panel 401 includes a first substrate 410, a second substrate 430 and a liquid crystal layer 420. The second substrate 430 is positioned corresponding to the first substrate 410. The liquid crystal layer 420 is interposed between the first and second substrates 410 and 430. The first substrate 410 includes a first base substrate 411 and a pixel electrode 412 on the first base substrate 411. The first substrate 410 may further include a plurality of pixel electrodes.

The second substrate 430 includes a second base substrate 431, a first black matrix 432, a color filter layer 433, a second black matrix 434, a color fluorescent layer 435, a reflective-polarizing layer 436 and a common electrode 437. The second substrate 430 may further include a plurality of color filter layers and a plurality of color fluorescent layers.

The first black matrix 432 is formed on the second base substrate 431 to form a plurality of first spaces positioned corresponding to a plurality of pixel regions, respectively. A red color filter, a green color filter and a blue color filter of the color filter layer 433 are formed in the first spaces, respectively.

The second black matrix 434 is formed on the color filter layer 433 to form a plurality of second spaces positioned corresponding to the first spaces, respectively. A red fluorescent layer R, a green fluorescent layer G and a blue fluorescent layer B of the color fluorescent layer 435 are formed in the second spaces, respectively.

The color fluorescent layer 435 may include a fluorescent material, a color changing material, a photo-luminescent material having the fluorescent material and the color changing material, etc.

The red fluorescent layer R includes a red fluorescent material that changes the bluish light into red light. The green fluorescent layer G includes a green fluorescent material that changes the bluish light into green light. The blue fluorescent layer B includes a blue fluorescent material that changes the bluish light into blue light.

Alternatively, the blue fluorescent layer B may include a transparent material. The blue fluorescent layer B may also be omitted. For example, when the wavelength of the bluish light is about 460 nm, an energy level of the bluish light is relatively low. Under these circumstances, it may be beneficial to include a blue fluorescent layer B in color fluorescent layer 435. However, when the wavelength of the bluish light is about 400 nm, the energy level of the bluish light is relatively high, and the blue fluorescent layer B may be omitted in the color fluorescent layer 435. Also, the color fluorescent layer 435 may include transparent material corresponding to the blue fluorescent layer B.

The reflective-polarizing layer 436 is on the color fluorescent layer 435. The reflective-polarizing layer 436 may include one or more multi-layered liquid crystal layers including cholesteric liquid crystals. Alternatively, the reflective-polarizing layer 436 may include a plurality of anisotropy layers having different refractive indexes. The reflective-polarizing layer 436 transmits bluish light and blue light, while red and green light is reflected from the reflective-polarizing layer 436.

The common electrode 437 corresponds to the pixel electrode 412. When a potential difference is applied to the common electrode 437 and the pixel electrode 412, an electric field is formed between the common electrode 437 and the pixel electrode 412. Liquid crystals of the liquid crystal layer 420 vary their arrangement in response to the electric field applied thereto, and thus the local light transmittance of the liquid crystal layer 420 is changed.

Hereinafter, a light path of the bluish light that is incident on the display panel 401 is described.

The bluish light that is incident into the display panel 401 passes through the first substrate 410 and the liquid crystal layer 420, in sequence, to be incident on the second substrate 430.

The bluish light incident on the second substrate 430 passes through the common electrode 437 and the reflective-polarizing layer 436 and is incident on the color fluorescent layer 435. When the bluish light is incident on the color fluorescent layer 435, red, green and blue fluorescent layers R, G and B generate red, green and blue light, respectively.

A portion of the red and green light that does not pass through the color fluorescent layer 435 is reflected from the reflective-polarizing layer 436 toward the color fluorescent layer 435 to be recycled.

The red, green and blue light generated from the red, green and blue fluorescent layers R, G and B are incident on the color filter layer 433 to be filtered. When the red, green and blue light generated from the red, green and blue fluorescent layers R, G and B are filtered by the color filter layer 433, an ultraviolet portion of each of the red, green and blue light is blocked by the color filter layer 433.

For example, a thickness of the color fluorescent layer 435 may be about 10 μm to about 15 μm, and the color filter layer 433 may have a smaller thickness than the color fluorescent layer 435.

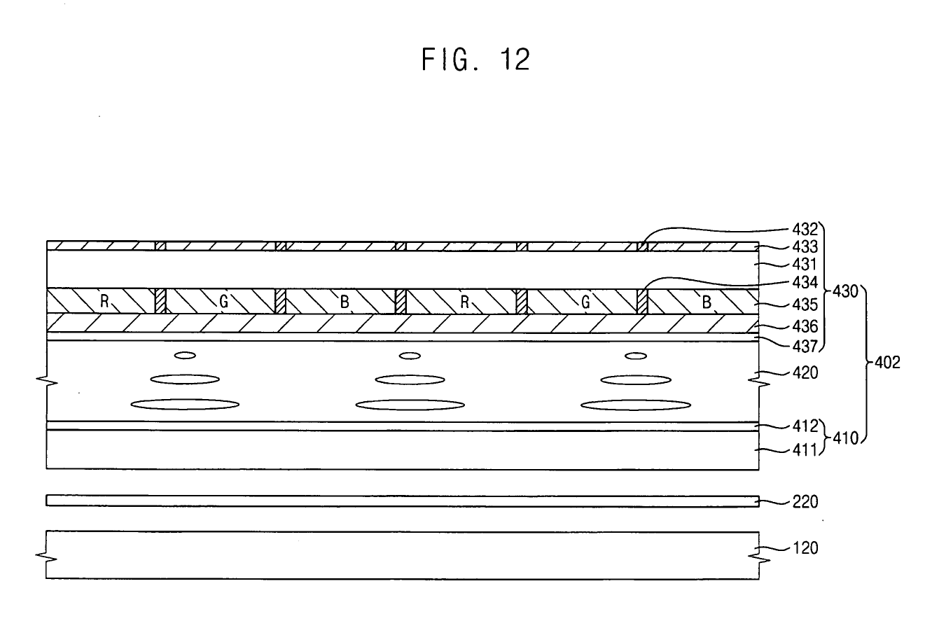

FIG. 12 is a cross-sectional view showing a display device in accordance with another embodiment of the present invention.

Referring to FIG. 12, the display device includes a light source member 120, a diffusion plate 220 and a display panel 402. The display device of FIG. 12 is same as in FIG. 11 except for the configuration of the display panel. Thus, the same reference numerals will be used to refer to the same or like parts as those described in FIG. 11 and further explanation concerning the above elements may be omitted.

The light source member 120 generates a bluish light having a wavelength of about 400 nm to about 500 nm. The diffusion plate 220 diffuses the bluish light generated from the light source member 120 to increase luminance uniformity.

The display panel 402 includes a first substrate 410, a second substrate 430 and a liquid crystal layer 420. The second substrate 430 is positioned corresponding to the first substrate 410. The liquid crystal layer 420 is interposed between the first and second substrates 410 and 430. The first substrate 410 includes a first base substrate 411 and a pixel electrode 412 on the first base substrate 411. The first substrate 410 may further include a plurality of pixel electrodes.

The second substrate 430 includes a second base substrate 431, a first black matrix 432, a color filter layer 433, a second black matrix 434, a color fluorescent layer 435, a reflective-polarizing layer 436 and a common electrode 437. The first black matrix 432 and the color filter layer 433 are on a first surface of the second base substrate 431. The second black matrix 434, the color fluorescent layer 435, the reflective-polarizing layer 436 and the common electrode 437 are formed on a second surface of the second base substrate 431. The second substrate 430 may further include a plurality of color filter layers and a plurality of color fluorescent layers.

The first black matrix 432 is formed on the first surface of the second base substrate 431 to form a plurality of first spaces. A red color filter, a green color filter and a blue color filter of the color filter layer 433 are formed in the first spaces, respectively. Alternatively, the blue color filter layer may be omitted. The blue color filter layer may include a transparent material.

The second black matrix 434 is formed on the second surface of the second base substrate 431 to form a plurality of second spaces. The second spaces may be positioned corresponding to the first spaces, respectively. A red fluorescent layer R, a green fluorescent layer G and a blue fluorescent layer B of the color fluorescent layer 435 are formed in the second spaces, respectively. Alternatively, the blue fluorescent layer may be omitted. The blue fluorescent layer may include a transparent material.

The color fluorescent layer 435 includes a fluorescent material, a color changing material, a photo-luminescent material having the fluorescent material and the color changing material, etc.

For example, when a wavelength of the bluish light is about 460 nm, an energy level of the bluish light is relatively low. Under these circumstances, it may be beneficial to include a blue fluorescent layer B in the color fluorescent layer 435. However, when the wavelength of the bluish light is about 400 nm, the energy level of the bluish light is relatively high, and the blue fluorescent layer B may be omitted in the color fluorescent layer 435. Also, the color fluorescent layer 435 may include the transparent material corresponding to the blue fluorescent layer B.

The reflective-polarizing layer 436 is on the color fluorescent layer 435. The reflective-polarizing layer 436 may have one or more multi-layered liquid crystal layers including cholesteric liquid crystals. Alternatively, the reflective-polarizing layer 436 may include a plurality of anisotropy layers having different refractive indexes. The reflective-polarizing layer 436 transmits the bluish light and the blue light, while the red and green light is reflected from the reflective-polarizing layer 436.

The common electrode 437 corresponds to the pixel electrode 412. When a potential difference is applied to the common electrode 437 and the pixel electrode 412, an electric field is formed between the common electrode 437 and the pixel electrode 412. Liquid crystals of the liquid crystal layer 420 vary their arrangement in response to the electric field applied thereto, and thus the local light transmittance of the liquid crystal layer 420 is changed.

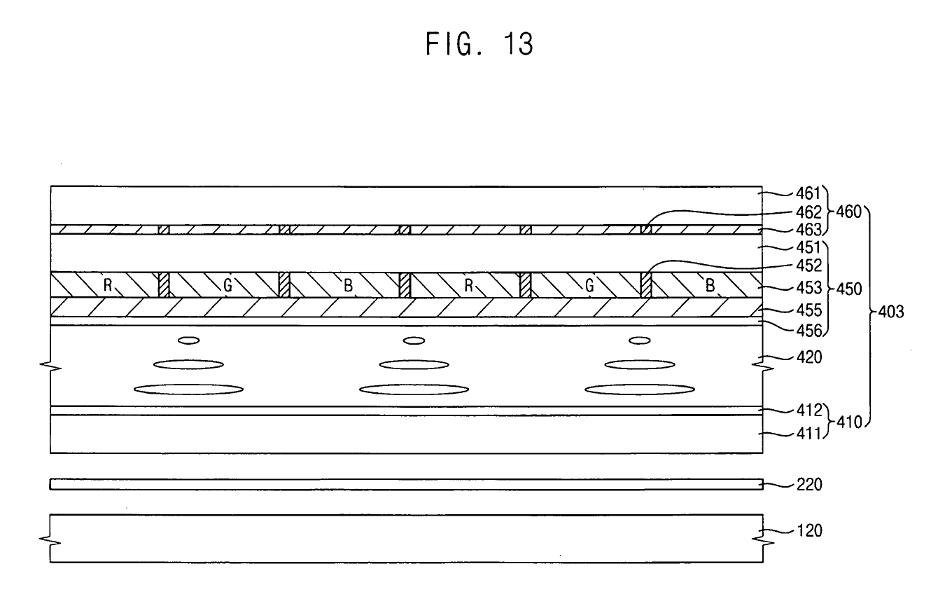

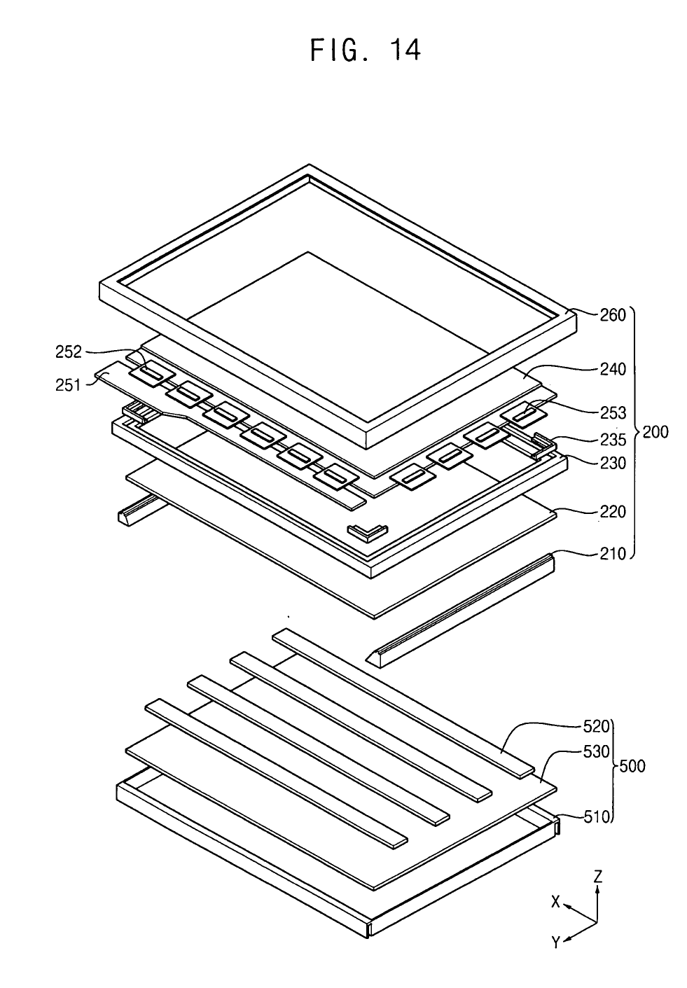

FIG. 13 is a cross-sectional view showing a display device in accordance with another embodiment of the present invention.

Referring to FIG. 13, the display device includes a light source member 120, a diffusion plate 220 and a display panel 403.

The light source member 120 generates a bluish light having a wavelength of about 400 nm to about 500 nm. The diffusion plate 220 diffuses the bluish light generated from the light source member 120 to increase luminance uniformity.

The display panel 403 includes a first substrate 410, a second substrate 450, a third substrate 460 and a liquid crystal layer 420.

The first substrate 410 includes a first base substrate 411 on which a pixel electrode 412 is formed.

The second substrate 450 is positioned corresponding to the first substrate 410. The liquid crystal layer 420 is interposed between the first and second substrates 410 and 450. The second substrate 450 includes a second base substrate 451, a first black matrix 452, a color fluorescent layer 453, a reflective-polarizing layer 455 and a common electrode 456. The first black matrix 452, the color fluorescent layer 453, the reflective-polarizing layer 455 and the common electrode 456 are on a first surface of the second base substrate 451. The first black matrix 452 defines a plurality of first spaces. A red fluorescent layer, a green fluorescent layer and a blue fluorescent layer of the color fluorescent layer 453 are formed in the first spaces, respectively. The red, green and blue fluorescent layers of the color fluorescent layer 453 generate red light, green light and blue light based on the bluish light, respectively.

The color fluorescent layer 453 may include a fluorescent material, a color changing material, a photo-luminescent material having the fluorescent material and the color changing material, etc.

The reflective-polarizing layer 455 may have one or more multi-layered liquid crystal layers including cholesteric liquid crystals. Alternatively, the reflective-polarizing layer 455 may include a plurality of anisotropy layers having different refractive indexes. The reflective-polarizing layer 455 transmits the bluish light and the blue light, while the red and green light is reflected from the reflective-polarizing layer 455.

The common electrode 456 corresponds to the pixel electrode 412. When a potential difference is applied to the common electrode 456 and the pixel electrode 412, an electric field is formed between the common electrode 456 and the pixel electrode 412. Liquid crystals of the liquid crystal layer 420 vary their arrangement in response to the electric field applied thereto, and thus the local light transmittance of the liquid crystal layer 420 is changed.

The third substrate 460 includes a third base substrate 461, a second black matrix 462 and a color filter layer 463. The second black matrix 462 is on a second surface of the second substrate 450. The second surface of the second substrate 450 is opposite the first surface of the second substrate 450. The second black matrix 462 and the color filter layer 463 are on the third base substrate 461. The second black matrix 462 defines a plurality of second spaces. A red color filter, a green color filter and a blue color filter of the color filter layer 463 are formed in the second spaces, respectively. The color filter layer 463 is interposed between the second surface of the second substrate 450 and the third substrate 460.

Hereinafter, a light path of the bluish light that is incident on the display panel 403 is described.

The bluish light that is incident on the display panel 403 passes through the first substrate 410 and the liquid crystal layer 420, in sequence, to be incident on the second substrate 450.

The bluish light incident on the second substrate 450 passes through the common electrode 456 and the reflective-polarizing layer 455 and is incident on the color fluorescent layer 453. When the bluish light is incident on the color fluorescent layer 453, the red, green and blue fluorescent layers R, G and B generate red, green and blue light, respectively. A portion of the red and green light that does not pass through the color fluorescent layer 453 is reflected from the reflective-polarizing layer 455 toward the color fluorescent layer 453 to be recycled.

The red, green and blue light generated from the red, green and blue fluorescent layers R, G and B pass through the second base substrate 451 and are incident on the third substrate 460. The red, green and blue light having passed through the second base substrate 451 are incident on the color filter layer 463 to be filtered. When the red, green and blue light generated by the red, green and blue fluorescent layers R, G and B are filtered by the color filter layer 463, an ultraviolet portion of each of the red, green and blue lights is blocked by the color filter layer 463.

For example, a thickness of the color fluorescent layer 453 may be about 10 μm to about 15 μm, and the color filter layer 463 may have a smaller thickness than the color fluorescent layer 453.

FIG. 14 is a perspective view showing a display device in accordance with another embodiment of the present invention.

Referring to FIG. 14, the display device includes a backlight assembly 500 and a display assembly 200. The backlight assembly 500 generates a bluish light. The display assembly 200 displays an image using the bluish light. The display assembly of FIG. 14 is same as in FIG. 1. Thus, the same reference numerals will be used to refer to the same or like parts as those described in FIG. 1, and further explanation concerning the above elements may be omitted.

The backlight assembly 500 includes a bottom chassis 510, an organic light emitting part 520 and a reflecting plate 530. The bottom chassis 510 has a receiving space to receive the organic light emitting part 520 and the reflecting plate 530.

The organic light emitting part 520 may include a plurality of organic light emitting elements arranged in a direct illumination type. Each of the organic light emitting elements generates the bluish light having a wavelength of about 400 nm to about 500 nm.

In FIG. 14, the organic light emitting elements are arranged in the direct illumination type. Alternatively, the organic light emitting elements may be arranged in a planar shape. The organic light emitting elements may also be arranged in the edge illumination type shown in FIG. 2. Display devices incorporating a backlight assembly including an organic light emitting part 520 may have reduced thickness and weight.

The reflecting plate 530 is positioned under the organic light emitting part 520 so a portion of the light leaked from the organic light emitting part 520 is reflected toward the display assembly 200.

The display assembly 200 includes a side mold 210, a diffusion plate 220, an upper mold 230, a display panel 240 and a top chassis 250.

The side mold 210 guides the portion of backlight assembly 100 that is under the side mold 210, and supports the diffusion plate 220 that is on the side mold 210. The diffusion plate 220 diffuses the bluish light generated from the backlight assembly 100 to supply the display panel 240 with the diffused bluish light.

The display panel 240 that is guided by a panel guide 235 is received in the upper mold 230. The upper mold 230 is combined with the side mold 210 to fix the diffusion plate 220 to the side mold 210.

The display panel 240 is received in the upper mold 230, and includes a first substrate, a second substrate, a liquid crystal layer and color fluorescent layers. The color fluorescent layers include a red fluorescent layer, a green fluorescent layer and a blue fluorescent layer. The liquid crystal layer is interposed between the first and second substrates. The red, green and blue fluorescent layers generate red light, green light and blue light, respectively. Alternatively, the blue fluorescent layer may be omitted. The display panel 240 displays an image using electrical and optical characteristics of the liquid crystals.

Each of the color fluorescent layers may include a fluorescent material, a color changing material, a photo luminescent material, etc.

A source printed circuit board 251, a data driving part 252 and a gate driving part 253 are mounted on a peripheral region of the display panel 240.

The top chassis 260 is combined with the upper mold 230 to fix the display panel 240 to the upper mold 230. In addition, the top chassis 260 is also combined with the bottom chassis 110 to fix the backlight assembly 100 and the display assembly 200 to the bottom chassis 110.

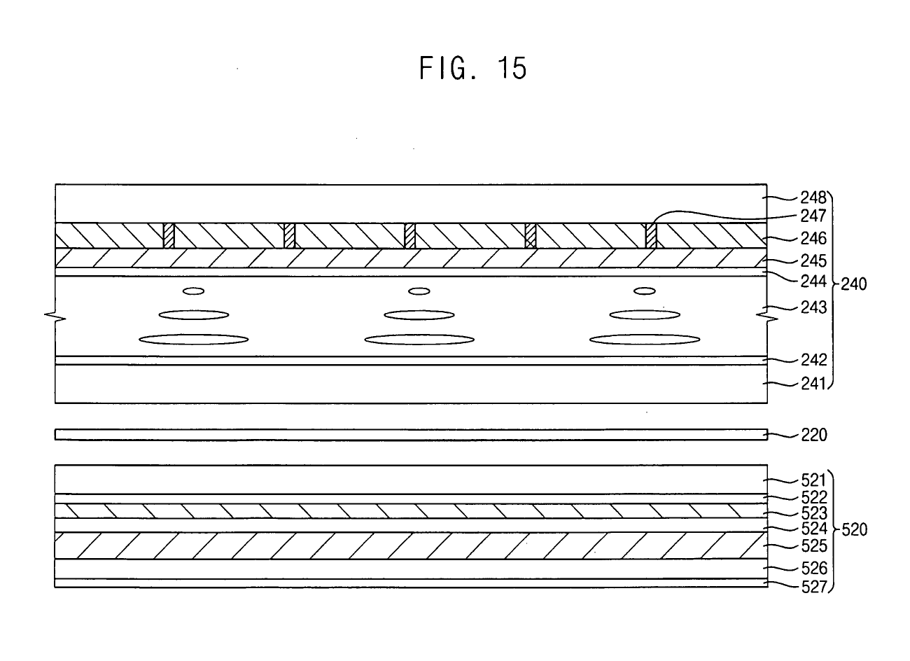

FIG. 15 is a cross-sectional view showing a display device shown in FIG. 14.

Referring to FIG. 15, the display device includes an organic light emitting part 520, a diffusion plate 220 and a display panel 240. The display panel of FIG. 15 is same as in FIG. 3. Thus, the same reference numerals will be used to refer to the same or like parts as those described in FIG. 3 and any further explanation concerning the above elements will be omitted.

The organic light emitting part 520 includes a base substrate 521, a transparent electrode 522, a positive charge injecting layer 523, a positive charge transporting layer 524, a bluish light emitting layer 525, a negative charge transporting layer 526 and a metal electrode 527.

Negative charges from the metal electrode 527 are combined with positive charges from the transparent electrode 522 to generate exitons. The bluish light is generated using the exitons of the organic light emitting part 520. The organic light emitting part 520 generates the bluish light having a wavelength of about 400 nm to about 500 nm.

The diffusion plate 220 diffuses the bluish light generated from the organic light emitting part 520 to increase luminance uniformity.

The display panel 240 includes a first substrate 241, a second substrate 248 and a liquid crystal layer 243. The second substrate 248 is positioned corresponding to the first substrate 241. The liquid crystal layer 243 is interposed between the first and second substrates 241 and 248.

The second substrate 248 includes a black matrix 247, color fluorescent layers 246, a reflective-polarizing layer 245 and a common electrode 244. The black matrix 247 defines a plurality of regions for the color fluorescent layers 246, respectively. The color fluorescent layers 246 include a red fluorescent layer R, a green fluorescent layer G and a blue fluorescent layer B. The red fluorescent layer R changes the bluish light into red light. The green fluorescent layer G changes the bluish light into green light. The blue fluorescent layer B changes the bluish light into blue light.

Each of the color fluorescent layers may include a fluorescent material, a color changing material, a photo-luminescent material having the fluorescent material and the color changing material, etc.

The reflective-polarizing layer 245 may have one or more multi-layered liquid crystal layers including cholesteric liquid crystals. Alternatively, the reflective-polarizing layer 245 may include a plurality of anisotropy layers having different refractive indexes.

The common electrode 244 corresponds to the pixel electrode 242. When a potential difference is applied to the common electrode 244 and the pixel electrode 242, an electric field is formed between the common electrode 244 and the pixel electrode 242. The liquid crystals of the liquid crystal layer 243 vary their arrangement in response to the electric field applied thereto, and thus the local light transmittance of the liquid crystal layer is changed.

Alternatively, the display panel 240 may be one of the display panels 401, 402 and 403 shown in FIG. 11, 12 or 13.

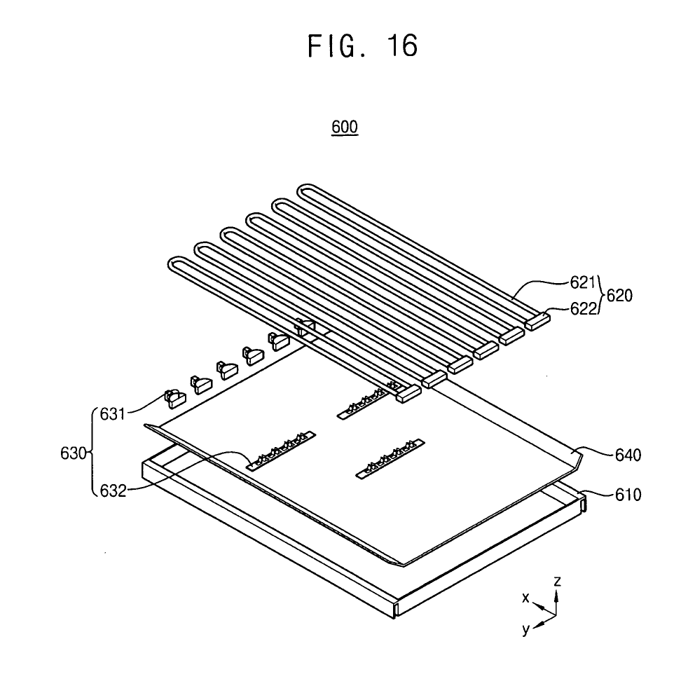

FIG. 16 is a perspective view showing a backlight assembly in accordance with another embodiment of the present invention.

Referring to FIG. 16, the backlight assembly 600 includes a bottom chassis 610, a light source member 620, a lamp guiding member 630 and a reflecting plate 640.

The bottom chassis 610 has a receiving space to receive the light source member 620, the lamp guiding member 630 and the reflecting plate 640.

The light source member 620 includes a cold cathode fluorescent lamp (CCFL) 621 and an electrode part 622. The CCFL 621 generates the bluish light having a wavelength of about 400 nm to about 500 nm. For example, the CCFL 621 may have a U-shape, an I-shape, an N-shape, an M-shape, etc. The electrode part 622 is electrically connected to an inverter (not shown) to apply electric power to the CCFL 621.

The lamp guiding member 630 includes a lamp holder 631 and a lamp supporter 632. The lamp guiding member 630 partially covers the CCFL 621 so that the reflecting plate 640 is spaced apart from the CCFL 621 by a constant distance. The lamp guiding part 630 is combined with the bottom chassis 610 through the reflecting plate 640.

The bluish light generated from the CCFL 621 is reflected from the reflecting plate 640.

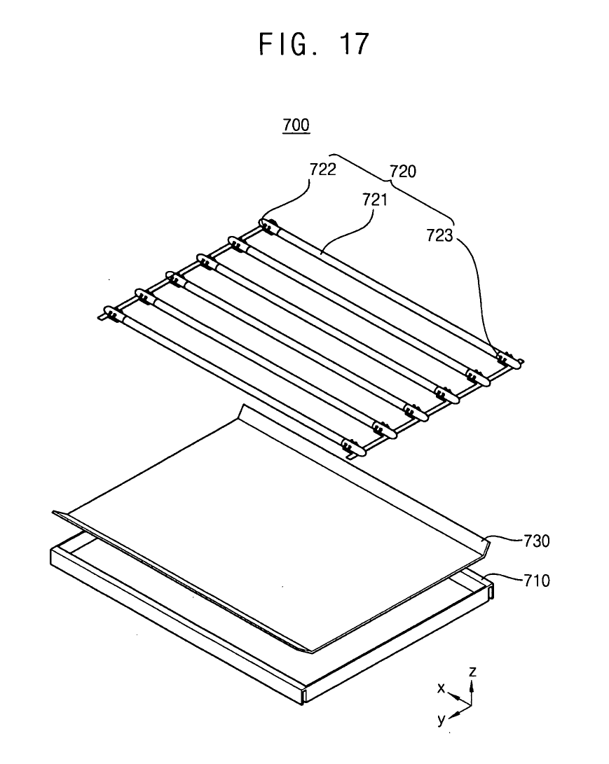

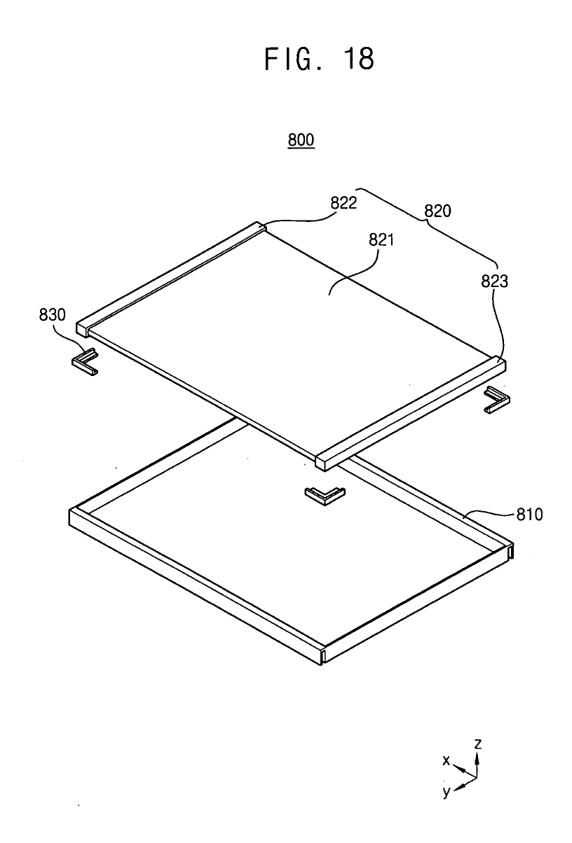

FIG. 17 is a perspective view showing a backlight assembly in accordance with another embodiment of the present invention.

Referring to FIG. 17, the backlight assembly 700 includes a bottom chassis 710, a light source member 720 and a reflecting plate 730.

The bottom chassis 710 has a receiving space to receive the light source member 720 and the reflecting plate 730.

The light source member 720 includes an external electrode fluorescent lamp (EEFL) 721, a first lamp clip 722 and a second lamp clip 723. The EEFL 721 generates a bluish light having a wavelength of about 400 nm to about 500 nm. The first and second lamp clips 722 and 723 are electrically connected to an inverter (not shown) to receive electric power and to transmit the electric power to the EEFL 721.

The bluish light generated from the EEFL 721 is reflected from the reflecting plate 730 toward a front of the backlight assembly 700.

FIG. 18 is a perspective view showing a backlight assembly in accordance with another embodiment of the present invention.

Referring to FIG. 18, the backlight assembly 800 includes a bottom chassis 810, a flat-typed light source member 820 and a supporting member 830.

The bottom chassis 810 has a receiving space to receive the flat-typed light source member 820 and the supporting plate 830.

The flat-typed light source member 820 includes a flat fluorescent lamp 821, a first electrode part 822 and a second electrode part 823. The first and second electrode parts 822 and 823 are on end portions of the flat fluorescent lamp 821. The flat-typed light source member 820 generates the bluish light having a wavelength of about 400 nm to about 500 nm.

In FIG. 18, ultraviolet light is generated in the flat fluorescent lamp 821, and the ultraviolet light is changed into a bluish light by a bluish fluorescent layer (not shown). The flat fluorescent lamp 821 has a large size, and includes a plurality of divided spaces, thereby increasing its luminance uniformity.

The supporting member 830 corresponds to the flat-typed light source member 820. The flat-typed light source member 820 is separated from the bottom chassis 810 by a substantially constant distance using the supporting member 830 so that the flat-typed surface light source member 820 is electrically insulated from the bottom chassis 810. In addition, the supporting member 830 protects the flat-typed light source member 820 from impact.

In FIG. 18, the supporting member 830 includes four pieces corresponding to four corners of the flat-typed light source member 820. Alternatively, the supporting member 830 may have various shapes such as an integrally formed frame shape.

Each of the CCFL, the EEFL and the flat-typed light source member includes the bluish fluorescent layer to generate the bluish light having a wavelength of about 400 nm to about 500 nm. That is, ultraviolet light is generated in a discharge space, and the bluish fluorescent layer converts the ultraviolet light into the bluish light.

The red, green and blue fluorescent layers may be formed on the black matrix. Alternatively, the black matrix may be omitted.

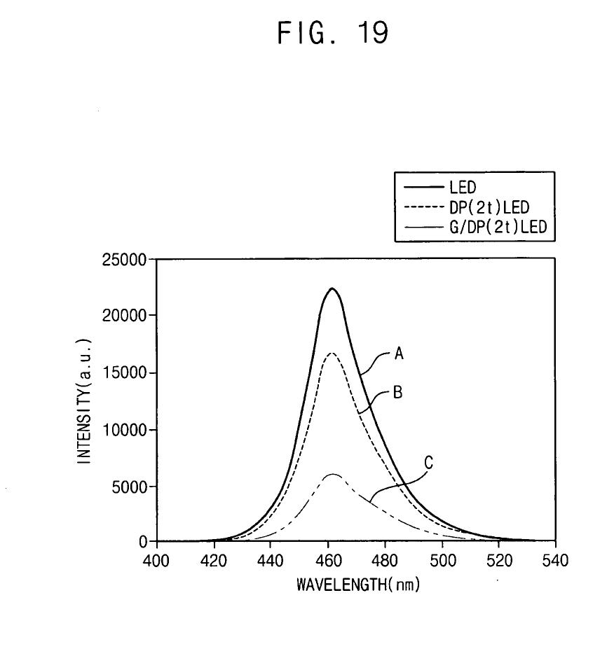

FIG. 19 is a graph showing a relationship between intensity and wavelength of a light generated from a bluish light source.

Referring to FIG. 19, a graph ‘A’ represents an intensity of the bluish light that is directly incident on a photo sensor. A graph ‘B’ represents an intensity of the bluish light that is incident on the photo sensor through a diffusion plate. A graph ‘C’ represents an intensity of the bluish light that is incident on the photo sensor through the diffusion plate and a color filter.

When the number of the optical members such as the diffusion plate and the color filter is increased, the intensity of the bluish light is decreased. In FIG. 19, a portion of a light can be used to generate visible light using a fluorescent layer.

The intensity of the light of the graph ‘C’ is smaller than that of the graph ‘B’ by about 50%. The luminance of the display device may be increased for a display panel that does not include the color filter layer.

According to embodiments of the present invention, the PL-LCD device displays the image using the bluish light to increase the luminance and the viewing angle.

In particular, the light generated from the light source has a Lambertian distribution to increase the viewing angle. In addition, the color reproducibility and the luminance of the light source generating the bluish light are greater than those of a light source generating visible light.

Furthermore, a brightness enhancement film may be omitted, providing for a lightweight and thin display device with reduced manufacturing cost.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A display device comprising:
a light source member configured to generate a bluish light;
a diffusion member configured to diffuse the bluish light and thereby to increase a luminance uniformity of the display device; and
a display panel including:
a liquid crystal layer;
a fluorescent layer configured to receive bluish light from the liquid crystal layer and to generate visible light based on the received bluish light; and
a reflective-polarizer that is configured to partially reflect the visible light generated by the fluorescent layer toward the fluorescent layer.

2. The display device of claim 1, wherein the bluish light includes light having a wavelength corresponding to an intensity maximum of the bluish light in the range from about 400 nm to about 500 nm.

3. The display device of claim 1, wherein the light source member comprises a bluish light emitting diode.

4. The display device of claim 1, wherein the light source member comprises a bluish organic light emitting diode.

5. The display device of claim 1, wherein the light source member comprises a cold cathode fluorescent lamp and a bluish fluorescent material.

6. The display device of claim 1, wherein the light source member comprises an external electrode fluorescent lamp and a bluish fluorescent material.

7. The display device of claim 1, wherein the light source member comprises a flat-typed fluorescent lamp and a bluish fluorescent material.

8. The display device of claim 1, wherein the fluorescent layer comprises at least one selected from the group consisting of a fluorescent material, a color change material and a photo luminescent material that includes a mixture of the fluorescent material and the color change material.

9. The display device of claim 1, wherein the reflective-polarizer is on the light source member, and wherein the fluorescent layer is on the reflective-polarizer.

10. The display device of claim 1, wherein the reflective-polarizer comprises:
a first liquid crystal layer including liquid crystals aligned in a first direction to reflect a light polarized in the first direction; and
a second liquid crystal layer on the first liquid crystal layer, the second liquid crystal layer including liquid crystals aligned in a second direction that is substantially opposite to the first direction to reflect a light polarized in the second direction.

11. The display device of claim 10, wherein the first liquid crystal layer comprises:
a first liquid crystal film configured to generate circularly polarized red light; and
a second liquid crystal film configured to generate circularly polarized green light.

12. The display device of claim 10, wherein the second liquid crystal layer comprises:
a third liquid crystal film configured to generate circularly polarized red light; and
a fourth liquid crystal film configured to generate circularly polarized green light.

13. The display device of claim 10, wherein each of the first and second liquid crystal layers comprises cholesteric liquid crystals.

14. The display device of claim 1, wherein the reflective-polarizer includes a plurality of layers, at least some of the layers having different refractive indexes.

15. The display device of claim 1, wherein the display panel comprises:
a first substrate including a first base substrate and a pixel electrode on the first base substrate; and
a second substrate attached to the first substrate to receive the liquid crystal layer, the second substrate including a second base substrate, the fluorescent layer, the reflective-polarizer and a common electrode.

16. The display device of claim 15, wherein the second substrate further comprises a black matrix to define a plurality of pixels positioned corresponding to associated fluorescent portions of the fluorescent layer.

17. The display device of claim 15, wherein the fluorescent layer comprises a red fluorescent layer, a green fluorescent layer and a blue fluorescent layer.

18. The display device of claim 15, wherein a wavelength of the bluish light corresponding to an intensity maximum of the bluish light is about 400 nm, and the fluorescent layer comprises a red fluorescent layer and a green fluorescent layer.

19. The display device of claim 1, wherein the display panel comprises:
a first substrate including a first base substrate and a pixel electrode on the first base substrate; and
a second substrate attached to the first substrate to receive the liquid crystal layer, the second substrate including a second base substrate, a color filter layer, the fluorescent layer, the reflective-polarizer and the common electrode.

20. The display device of claim 19, wherein the second substrate further comprises a first black matrix to define a plurality of pixel regions positioned corresponding to associated color filter portions of the color filter layer.

21. The display device of claim 19, wherein the second substrate further comprises a second black matrix to define a plurality of pixel regions positioned corresponding to associated fluorescent portions of the fluorescent layer.

22. The display device of claim 19, wherein a wavelength of the bluish light corresponding to an intensity maximum of the bluish light is about 400 nm, and wherein the fluorescent layer comprises a red fluorescent layer and a green fluorescent layer.

23. The display device of claim 1, wherein the display panel comprises:
a first substrate including a first base substrate and a pixel electrode on the first base substrate; and
a second substrate attached to the first substrate to receive the liquid crystal layer, the second substrate including a second base substrate, the fluorescent layer on a first surface of the second base substrate, the reflective-polarizer on the first surface of the second base substrate, and a color filter layer on a second surface of the second base substrate.

24. The display device of claim 23, wherein the second substrate further comprises a first black matrix to define a plurality of pixel regions positioned corresponding to associated color filter portions of the color filter layer.

25. The display device of claim 23, wherein the second substrate further comprises a second black matrix to define the plurality of pixel regions corresponding to associated fluorescent portions of the fluorescent layer.

26. The display device of claim 23, wherein a wavelength of the bluish light corresponding to an intensity maximum of the bluish light is about 400 nm, and wherein the fluorescent layer comprises a red fluorescent layer and a green fluorescent layer.

27. The display device of claim 1, wherein the display panel comprises:
a first substrate including a first base substrate and a pixel electrode on the first base substrate;
a second substrate attached to the first substrate to receive the liquid crystal layer, the second substrate including a second base substrate, the fluorescent layer on a first surface of the second base substrate, the reflective-polarizer on the first surface of the second base substrate, and a common electrode on the first surface of the second base substrate; and
a third substrate on a second surface of the second base substrate, the third substrate including a third base substrate and a color filter layer on the third base substrate.

28. The display device of claim 27, wherein the second substrate further comprises a first black matrix to define a plurality of pixel regions positioned corresponding to associated fluorescent portions of the fluorescent layer.

29. The display device of claim 27, wherein the third substrate further comprises a second black matrix to define a plurality of pixel regions positioned corresponding to associated color filter portions of the color filter layer.

30. The display device of claim 27, wherein a wavelength of the bluish light corresponding to an intensity maximum of the bluish light is about 400 nm, and wherein the fluorescent layer comprises a red fluorescent layer and a green fluorescent layer.

31. A display device comprising:
a light source member configured to generate a bluish light having a wavelength corresponding to a maximum intensity of the bluish light included in the range of about 400 nm to about 500 nm;
a diffusion member configured to diffuse the bluish light and thereby to increase a luminance uniformity of the display device; and
a display panel including:
a liquid crystal layer;
a fluorescent layer configured to receive bluish light from the diffusion member and to generate a first visible light based on the received bluish light; and
a reflective-polarizer configured to partially reflect the first visible light generated by the fluorescent layer toward the fluorescent layer.

32. The display device of claim 31, wherein a red light and a green light of the first visible light are reflected by the reflective-polarizer.

33. The display device of claim 31, wherein the display panel further comprises a color filter layer configured to convert the first visible light into a second visible light.

34. The display device of claim 31, wherein the display panel further comprises a black matrix to define a plurality of pixel regions on the display panel.

35. A display device comprising:
a light source member configured to generate a bluish light including light having a wavelength corresponding to an intensity maximum of the bluish light included in the range of about 400 nm to about 500 nm;
a diffusion member configured to diffuse the bluish light to thereby increase a luminance uniformity of the display device; and
a display panel including:
a liquid crystal layer;
a fluorescent layer configured to receive blush light from the diffusion member and to generate a first visible light based on the received bluish light;
a reflective-polarizer configured to partially reflect the first visible light generated by the fluorescent layer toward the fluorescent layer; and
a color filter layer configured to convert the first visible light into a second visible light.

36. The display device of claim 35, wherein a red light and a green light of the first visible light are reflected from the reflective-polarizer.

37. A display apparatus comprising:
a light source configured to generate light having an intensity maximum at a wavelength included in the range from about 400 nm to about 500 nm; and
a fluorescent layer configured to receive the light generated from the light source and further configured to generate first light having an intensity maximum corresponding to a first color and to generate second light having an intensity maximum corresponding to a second color, the fluorescent layer generating the first light and the second light in response to receiving the light from the light source.

38. The apparatus of claim 37, wherein the first color is red and the second color is green.

39. The apparatus of claim 37, wherein the fluorescent layer is further configured to generate third light having an intensity maximum corresponding to a third color, the fluorescent layer generating the third light in response to receiving the light from the light source.

40. The apparatus of claim 37, further comprising a display panel generating images using the first and second lights.

41. The apparatus of claim 37, wherein the light source includes a source of ultraviolet light and an associated layer configured to receive the ultraviolet light and to generate the light having the intensity maximum at the wavelength included in the range from about 400 nm to about 500 nm.
